(19) United States
(12) Patent Application Publication
(10) Pub. No.: US 2024/0346749 A1
(43) Pub. Date: Oct. 17, 2024

(54) SYSTEMS, METHODS AND APPARATUS FOR UNIVERSAL TRACKING AND SENSING FOR USE IN DIGITALLY SIMULATED ENVIRONMENTS

(71) Applicant: ChimeraXR Incorporated, Whitby (CA)

(72) Inventors: Taylor MCCUBBIN-FREER, Toronto (CA); Tom WAJDA, Oshawa (CA)

(21) Appl. No.: 18/058,759

(22) Filed: Nov. 24, 2022

Related U.S. Application Data
(60) Provisional application No. 63/283,026, filed on Nov. 24, 2021.

(51) Int. Cl. G06T 17/00; G06T 7/20

(52) U.S. Cl. CPC G06T 17/00; G06T 7/20

(57) ABSTRACT

The present invention relates generally to a tracking and sensing apparatus of wired or wireless operation for universal use in digitally simulated environments having controls that are electromechanically connected to operational mechanical parts of any tool for use with any headset. More particularly, the present invention relates to a universal mounting and sensing tool that offers maintaining the unmodified controller for tracking purposes while adding sensing capabilities for inputs and outputs via a circuit board.

This application claims the benefit of U.S. Provisional Application No. 63/283,026, filed Nov. 24, 2021, the contents of which is incorporated herein by reference.

### FIELD OF INVENTION

The present invention relates generally to systems, apparatus and methods for adapting wired or wireless augmented or virtual reality controller(s) that may be electromechanically connected to any object for universal tracking and monitoring thereof. More particularly, the present invention relates to removably affixing controllers to any object while maintaining head-mounted display (HMD) manufacturer's proprietary tracking systems for use in virtual training systems.

### BACKGROUND TO THE INVENTION

Given the lack of options to detect and track objects with conventional head-mounted display (HMD) systems, there may be a desire to create an option which provides both tracking and sensing/detecting/monitoring in one package for any object in order to facilitate the HMD use associated therewith. Training the use of conventional objects in virtual, augmented or mixed reality requires a tracking method and sensing/detecting/monitoring method appropriate to the HMD in question. Alternatives to tracking have been developed for training. These alternatives include paintball and the use of lasers. In the case of weapons training or use simulation, however, such alternatives do not duplicate substantially all of the characteristics of firing an actual weapon with actual ammunition, and the current alternatives limit the extent to which such training will carry over to use of actual firearms. A virtual reality-based simulated environment using existing equipment is therefore ideal. Simulated firearms training, for example, employs a simulated version of a real firearm to shoot at an imaginary target in an imagined environment, such as virtual, augmented or mixed reality.

Virtual, augmented or mixed reality are forms of computer-generated simulations that utilize, but is not limited to, motion tracked headsets or glasses accompanied with motion tracked hand held controllers to immerse a person in a digitally augmented or full 360-degree digital environment and allow them to interact with the environment by using the supplied headset, controllers and inputs. An object of a “virtual reality system” may be to give users the ability to explore environments that exist only as models in the memory of a computer. These environments can be models of the real world (e.g., streets of a city, or the interior of a building). A typical virtual or augmented reality system consists of a computer, input devices, and an output device. The computer maintains the model of the virtual world and calculates its appearance from the viewpoint of the user. The output device may be often an apparatus that mounts on the user's head and may be either a display or screen mounted to a helmet or a pair of goggles. By wearing the helmet, the user visually immerses himself or herself in the virtual world. Also, attached to the helmet are tracking devices that enable the computer to know about the position of the user's head and in what direction the user may be looking. For training, the input device may be any object which may be required so long as it may be tracked and sensored/detected/monitored for the headset.

Augmented (“AR”), virtual (“VR”) or mixed reality (“MR”) systems may be employed in training or entertainment use cases, with the use of physical (i.e. not digital) objects to increase immersion and value of the use case. With the advances of AR or VR education or entertainment use cases, some systems may employ an attachment or peripheral to represent a real object in the AR/VR environment, attempting to simulate the look, feel and function of the object to provide the user with more realistic experiences. The characteristics of a real object to be duplicated can include size, weight, grip configuration, trigger reach, trigger pull weight, type of sights, level of accuracy, method of reloading, method of operation, location and operation of controls, movement (e.g. recoil) and the like. In cases of simulated training or entertainment that require a user to operate a simulated object such as, for example, firearms (e.g. rifles, pistols, shotguns, sniper rifles, submachine guns, machine guns, rocket launchers, projectile launchers (e.g. grenades, tear gas, etc.), handguns, conducted energy weapons, miniguns, artillery guns, mortars, automatic firearms, etc.), fire hoses, defibrillators, hockey sticks, tennis rackets, soccer balls, footballs, baseball bats, bowling balls, golf clubs, boxing gloves, levers and pulleys, assembly line equipment, etc. A user generally must hold the simulated object in such a way that mimics holding the object with complete accuracy in position and function. No universal devices have been developed to help meet this requirement as it pertains to virtual, augmented or mixed reality devices. While some devices allow for the attachment of tracking items or controllers, and some devices allow for the sensing, detecting, and/or monitoring of objects, existing devices fail to provide a universal applicability and all such functionality (e.g. both sensing/detecting/monitoring and tracking) in one. More devices offer a way to physically attach a controller to an object but do not allow for both attaching and sensing/detecting/monitoring; these systems suffer significant drawbacks that hinder the user's experience resulting in such simulated training programs not being sufficient nor utilized to their full potential.

Significant limitations must be overcome to allow an object in an AR/VR/MR environment to be tracked and detected/monitored so as to be useful in a virtual training or entertainment environment such that the simulated object looks and functions identically to object in the real world. Thus, there may be a need for an economical and universal apparatus, method and system to connect to real-world objects having particular functions allowing for two-way communication (e.g. allow both output and input to and from the device), display such functional real-world objects in an AR/VR/MR ecosystem (including on an HMD), allow the movement and function(s) of the real-world objects to be accurately translated into the virtual environment, and allow feed back from the virtual environment to the real world object. In particular, there may be a need for an economical and universal apparatus, method and system that can be modularly attached and/or connected to a real-world object without modification of the controller or serious modification of the real-world object in order to receive inputs or send outputs to the HMD, while maintaining the original AR/VR/MR ecosystem peripherals for tracking the object.

There remains a need for objects and related accessories that can be used in simulated entertainment or training environments with greater realism and accuracy which will provide a fulfilling experience utilizing the full potential of the software program.

### SUMMARY OF THE INVENTION

Accordingly, it is an aspect of this invention to overcome some of the disadvantages of the prior art.

The present invention is directed to systems, apparatus and methods for sensing/detecting/monitoring and tracking a real-world object having specific functions in an AR/VR training or entertainment environment or system and connecting to such real-world objects so as to allow for two-way communication (e.g. allowing both output from and input into the device). Another aspect of the invention provides the display of such functional real-world object(s) in an AR/VR HMD ecosystem, allowing the movement and function(s) of the real-world object(s) to be accurately translated into the virtual environment, and allowing feed back from the virtual world to the real world object and vis versa (e.g. allowing two-way communication).

An aspect of the present invention may be directed to an economical and universal apparatus, method and system to connect to real-world objects having particular functions, display such functional real-world objects in an AR/VR HMD ecosystem, and allow the functions of the real-world objects to be accurately translated in the virtual environment with feedback from the virtual environment. In yet another aspect of the present invention, there may be provided systems, apparatus, and methods that allow for existing AR/VR controllers to be modularly attached or connected to a real object without modification of the controller or serious modification of the object in order to receive inputs or send outputs to the HMD, while maintaining the original HMD peripherals for tracking the object.

Another aspect of the present invention may be directed to AR/VR HMD ecosystem such as the Meta Quest, the Meta Quest 2, the Pico Neo, the Pico Neo 2, the HP Reverb, the PSVR, the Valve Index, the Pimax 8K X, the Microsoft Hololens, the Microsoft Hololens 2, the Magic Leap, the Magic Leap 2, the Lynx R-1, HP Reverb G2, the HP Reverb and similar or future iterations of these headsets.

Yet another aspect of the present invention may be directed to apparatus, systems and methods for receiving inputs and providing outputs without any modification to the headset or controllers, and for use with education or entertainment based equipment in a virtual, mixed or augmented reality environment. The inventive devices, methods and systems of the present invention allow for connecting a communication device to an operational/functional object or piece of equipment to be used in a virtual, mixed or augmented reality environment while maintaining the proprietary tracking method provided by the virtual, mixed or augmented reality equipment manufacturer or a third party tracking method to track the position of the object. The invention allows a seamless simulation to provide an optimal virtual training environment. Finally, the present invention provides for highly accurate operational equipment to be used in a virtual or augmented environment allowing for optimal training, while minimizing downtime.

An aspect of the present invention may be directed to any object that needs to be represented in virtual environments in terms of appearance (e.g. shape and operation) and function (e.g. firing when trigger may be activated) like the real object in order to be used in a virtual environment.

### BRIEF DESCRIPTION OF THE DRAWINGS

In the drawings, which illustrate embodiments of the invention:

FIGS. 1 to 20 provide preferred embodiment of the present invention.

### DESCRIPTION OF THE PREFERRED EMBODIMENTS

The description that follows, and the embodiments described therein, is provided by way of illustration of an example, or examples, of particular embodiments of the principles and aspects of the present invention. These examples are provided for the purposes of explanation, and not of limitation, of those principles and of the invention.

It should also be appreciated that the present invention can be implemented in numerous ways, including as a process, method, an apparatus, a system, a device or a method. In this specification, these implementations, or any other form that the invention may take, may be referred to as processes. In general, the order of the steps of the disclosed processes may be altered within the scope of the invention. The description that follows, and the embodiments described therein, is provided by way of illustration of an example, or examples, of particular embodiments of the principles and aspects of the present invention. These examples are provided for the purposes of explanation, and not of limitation, of those principles and of the invention.

It will be understood by a person skilled in the relevant art that in different geographical regions and jurisdictions these terms and definitions used herein may be given different names, but relate to the same respective systems.

In VR/AR/MR systems, a user typically looks at least one VR projection or display device, such as a headset, helmet, goggles, or glasses (referred to herein as a head-mounted display (“HMD”)) that presents a selected virtual reality environment in front of the user's eyes. The HMD may include a projector mechanism for projecting or displaying frames including left and right images to a passenger's eyes to thus provide 3D virtual views. The 3D virtual views may include views of the user's virtual environment (e.g., virtual objects, virtual persons, etc.). In some VR systems, a user can manipulate items in the virtual environment with controllers, such handheld controllers well known in the art. Typically, a controller of the VR system includes the functionality or ability to track movement. The VR system then monitors the movement of the controller to represent the movement of the user and then reproduces the user's controller movements in the virtual environment. In some embodiments of the present invention, the VR system may include one or more controllers needing to be associated with or connected to a physical object whereby the controller receives and transmits data from the physical simulated object about the operation of the physical simulated object for the VR system; this data in turn may be designed to be projected or otherwise provided to one or more display device (typically an HMD). This could apply to any object needing to be simulated with a method of tracking and inputs of data, as it applies to the HMD's mentioned above, for objects such as firearms, sports equipment, industrial equipment and so on.

A person skilled in the art will understand that embodiments of the VR/AR/MR system may integrate inputs from a number of sources other than the controller, including but not limited to sensors (e.g., depth cameras (e.g., LiDAR) and video cameras), vehicle and HMD inertial-measurement units (IMUs), world maps, 3D models, video, audio, and other information from external sources such as cloud-based storage or network-based applications, video or audio inputs from other users and user devices such as notebook computers, tablets, or smartphones, to generate immersive virtual content for output through HMDs or other VR projection systems.

As used herein, the term “firearm” means a weapon used to fire a projectile or a portion of weapon capable of firing a projectile. For example, a firearm means a weapon such as a rifle, hand gun, pistol, shotgun, sniper rifle, submachine gun, machine gun, rocket launcher, self-propelled grenade (or other projectile) launcher, conducted energy weapon, minigun, artillery gun, mortars, automatic or semi automatic firearm or a portion thereof such as, for example, the disassembled barrel of weapon that may be capable of firing a projectile either alone or in combination with another element such as, for example, a triggering element. A person skilled in the art will understand the term “physical simulated firearm” means an actual or physical firearm or portion thereof that has been that modified so as not to be able to fire a projectile but in all other aspects (e.g. weight, operation (e.g. loading, unloading, etc.) center of gravity, etc.) may be substantively similar to a physical non-simulated firearm.

Although the present specification describes components and functions implemented in the embodiments with reference to standards and protocols known to a person skilled in the art, the present disclosure as well as the embodiments of the present invention are not limited to any specific standard or protocol. Each of the standards for Internet and other forms of computer network transmission (e.g., TCP/IP, UDP/IP, HTML, HTTP, SSL and SFTP) represent examples of the state of the art. Such standards are periodically superseded by faster or more efficient equivalents having essentially the same functions. Accordingly, replacement standards and protocols having the same functions are considered equivalents.

Preferred embodiments of the present invention can be implemented in numerous configurations depending on implementation choices based upon the principles described herein. Various specific aspects are disclosed, which are illustrative embodiments not to be construed as limiting the scope of the disclosure. Although the present specification describes components and functions implemented in the embodiments with reference to standards and protocols known to a person skilled in the art, the present disclosures as well as the embodiments of the present invention are not limited to any specific standard or protocol.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. may be here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

A person skilled in the art will understand that a component of the present invention may involve machine learning and/or artificial intelligence in order to assist at representing the firearm in data processing or computer operations. A person skilled in the art will understand that the present description will reference terminology from the field of artificial intelligence, including machine learning, and may be known to such a person skilled in the relevant art. A person skilled in the relevant art will also understand that artificial neural networks generally refer to computing or computer systems that are designed to mimic biological neural networks (e.g. animal brains). Such systems “learn” to perform tasks by considering examples, generally being programmed with or without task-specific rules. A person skilled in the relevant art will understand that convolutional neural networks, recurrent neural networks, transformer neural networks are classes of neural networks that specializes in processing data that has a grid-like or sequential-like topology.

Machine learning techniques will generally be understood as being used to identify and classify specific reviewed data. Machine learning approaches first tend to involve what may be known in the art as a “training phase”. In the context of classifying functions, a training “corpus” may be first constructed. This corpus typically comprises a set of known data. Each set is optionally accompanied with a “label” of its disposition. It may be preferable to have fewer unknown samples. Furthermore, it may be preferable for the corpus to be representative of the real-world scenarios in which the machine learning techniques will ultimately be applied. This may be followed by a “training phase” in which the data together with the labels associated with the data, files, etc. themselves, are fed into an algorithm that implements the “training phase”. The goal of this phase may be to automatically derive a “generative model”. A person skilled in the relevant art will understand that a generative model effectively encodes a mathematical function whose input may be the data and whose output may be also the data. By exploiting patterns that exist in the data through the training phase, the model learns the process that generates similar patterns. A generative machine learning algorithm should ideally produce a generator that may be reasonably consistent with the training examples and that has a reasonable likelihood of generating new instances that are similar to its training data but not identical. Specific generative machine learning algorithms in the art include the Autoregressive Recurrent Neural Networks, Variational Auto-Encoders, Generative Adversarial Neural Networks, Energy-Based Models, Flow-Based Neural Networks, and others known in the art. The term generator may be also used to describe a model. For example, one may refer to a Recurrent Neural Network Generator. Once the model/generator may be established, it can be used to generate new instances, scenarios or data sets that are presented to a computer or computer network in practice.

The present invention may be a system, a method, and/or a computer program product such that selected embodiments include software that performs certain tasks. The software discussed herein may include script, batch, or other executable files. The software may be stored on a machine-readable or computer-readable storage medium, and may be otherwise available to direct the operation of the computer system as described herein and claimed below. In one embodiment, the software uses a local or database memory to implement the data transformation and data structures so as to automatically generate and add libraries to a library knowledge base for use in detecting library substitution opportunities, thereby improving the quality and robustness of software and educating developers about library opportunities and implementation to generate more readable, reliable, smaller, and robust code with less effort. The local or database memory used for storing firmware or hardware modules in accordance with an embodiment of the invention may also include a semiconductor-based memory, which may be permanently, removably or remotely coupled to a microprocessor system. Other new and various types of computer-readable storage media may be used to store the modules discussed herein. Additionally, those skilled in the art will recognize that the separation of functionality into modules may be for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

In addition, selected aspects of the present invention may take the form of an entirely hardware embodiment, an entirely software embodiment (including firmware, resident software, micro-code, etc.), or an embodiment combining software and/or hardware aspects that may all generally be referred to herein as a “circuit,” “module” or “system.” Furthermore, aspects of the present invention may take the form of computer program product embodied in a computer readable storage medium or media having computer readable program instructions thereon for causing a processor to carry out aspects of the present invention. Thus embodied, the disclosed system, a method, and/or a computer program product may be operative to improve the design, functionality and performance of software programs by adding libraries for use in automatically detecting and recommending library function substitutions for replacing validated code snippets in the software program.

A person skilled in the relevant art will understand that the term “deep learning” refers to a type of machine learning based on artificial neural networks. Deep learning may be a class of machine learning algorithms (e.g. a set of instructions, typically to solve a class of problems or perform a computation) that use multiple layers to progressively extract higher level features from raw input. For example, in image processing, lower layers may identify edges, while higher layers may identify human-meaningful items such as digits or letters or faces.

The present invention may be a system, a method, and/or a computer program product such that selected embodiments include software that performs certain tasks. The software discussed herein may include script, batch, or other executable files. The software may be stored on a machine-readable or computer-readable storage medium, and may be otherwise available to direct the operation of the computer system as described herein and claimed below. In one embodiment, the software uses a local or database memory to implement the data transformation and data structures so as to automatically generate and add libraries to a library knowledge base for use in detecting library substitution opportunities, thereby improving the quality and robustness of software and educating developers about library opportunities and implementation to generate more readable, reliable, smaller, and robust code with less effort. The local or database memory used for storing firmware or hardware modules in accordance with an embodiment of the invention may also include a semiconductor-based memory, which may be permanently, removably or remotely coupled to a microprocessor system. Other new and various types of computer-readable storage media may be used to store the modules discussed herein. Additionally, those skilled in the art will recognize that the separation of functionality into modules may be for illustrative purposes. Alternative embodiments may merge the functionality of multiple software modules into a single module or may impose an alternate decomposition of functionality of modules. For example, a software module for calling sub-modules may be decomposed so that each sub-module performs its function and passes control directly to another sub-module.

In addition, selected aspects of the present invention may take the form of an entirely hardware embodiment, an entirely software embodiment (including firmware, resident software, micro-code, etc.), or an embodiment combining software and/or hardware aspects that may all generally be referred to herein as a “circuit,” “module” or “system.” Furthermore, aspects of the present invention may take the form of computer program product embodied in a computer readable storage medium or media having computer readable program instructions thereon for causing a processor to carry out aspects of the present invention. Thus embodied, the disclosed system, a method, and/or a computer program product may be operative to improve the design, functionality and performance of software programs by adding libraries for use in automatically detecting and recommending library function substitutions for replacing validated code snippets in the software program.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A person skilled in the relevant art will understand that the computer readable program instructions described herein can be downloaded to respective computing/processing devices from a computer readable storage medium or to an external computer or external storage device via a network, for example, the Internet, a Public Switched Circuit Network (PSTN), a packet-based network, a personal area network (PAN), a local area network (LAN), a wide area network (WAN), a wireless network, or any suitable combination thereof. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Visual Basic.net, Ruby, Smalltalk, C++ or the like, and conventional procedural programming languages, such as the “C” programming language, Hypertext Precursor (PHP), or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. A person skilled in the relevant art will understand that the Al based or algorithmic processes of the present invention may be implemented in any desired source code language, such as Python, Java, and other programming languages and may reside in private software repositories or online hosting service such as Github.

A person skilled in the art will understand that the operation of the network ready device (e.g. mobile device, work station, etc.) may be controlled by a variety of different program modules. Examples of program modules are routines, programs, objects, components, data structures, etc. that perform particular tasks or implement particular abstract data types. It will be understood that the present invention may also be practiced with other computer system configurations, including multiprocessor systems, microprocessor-based or programmable consumer electronics, network PCS, minicomputers, mainframe computers, and the like. Furthermore, the invention may also be practiced in distributed computing environments where tasks are performed by remote processing devices that are linked through a communications network. In a distributed computing environment, program modules may be located in both local and remote memory storage devices. One skilled in the relevant art would appreciate that the device connections mentioned herein are for illustration purposes only and that any number of possible configurations and selection of peripheral devices could be coupled to the computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “creating,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

In the following specification, it will be understood by a person skilled in the relevant art that the term “user” refers to a person who makes use of the embodiments of the present invention and the term “user” shall refer to a user of the system, apparatus and methods recited herein.

Embodiments of the present invention can be implemented by a software program for processing data through a computer system. It may be understood by a person skilled in the relevant art that the computer system can be a personal computer, mobile device, notebook computer, server computer, mainframe, networked computer (e.g., router), workstation, and the like. In one embodiment, the computer system includes a processor coupled to a bus and memory storage coupled to the bus. The memory storage can be volatile or non-volatile (i.e. transitory or non-transitory) and can include removable storage media. The computer can also include a display, provision for data input and output, etc. as will be understood by a person skilled in the relevant art. In some embodiments, one or more software programs to be executed by processing unit(s) can be stored on the device. “Software” refers generally to sequences of instructions that, when executed by processing unit(s) cause computing systems to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage, processing unit(s) can retrieve program instructions to execute and data to process in order to execute various operations described herein. In one embodiment, the computer system includes a processor coupled to a bus and memory storage coupled to the bus. The computer can also include a display, provision for data input and output, etc. as may be understood by a person skilled in the relevant art.

A person skilled in the art will understand that, with regard to a preferred embodiment of the present invention, the software of the present invention may be directed to a simulated digital environment (e.g. VR/AR/mixed reality) that creates a firearms training environment for the user. The software of the present invention, in a preferred embodiment, may use artificial intelligence and machine learning to provide the necessary training environment. In the simulated digital environment.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. may be here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

There may be disclosed herein various embodiments of a universal tracking and sensing/detecting/monitoring apparatus, which may be useful for allowing a user to train or play with the proper operation of any object in a virtual environment (e.g. a physical item or accessory for VR/AR/MR training). In accordance with the various embodiments described herein, there may be provided a modular, adjustable, and customizable tracking and sensing apparatus and system, including a controller mount, for use with existing, conventional controllers, to convert existing objects into a simulated object that has the look, feel and function of a real object. In turn, an aspect of the present invention may be to provide a conventional VR/AR/MR ecosystem controller with an attachment, without significantly modifying the controller. The disclosed embodiments of the present invention allow users to have an improved virtual entertainment or training experience.

A person skilled in the art will understand that the term “controller” means a networked or network ready mobile device acting, directly or indirectly, as a communication (receiving inputs and sending outputs) device for the VR/AR system. A controller of the present invention may have a variety of action buttons, triggers, thumbsticks and the like that allow navigation and selection of features in the VR environment. In a preferred embodiment of the present invention, a person skilled in the relevant art will understand that the present system employs a pre-existing controller within a particular VR/AR/MR ecosystem which can be used to track an functional object while simultaneously providing a modular sensing apparatus/system for the object. As a result, the present invention can be employed across multiple VR/AR/MR ecosystems with any object providing a “universal” apparatus or system. It will be understood that the pre-existing controller may be, directly or indirectly, operatively connected (wirelessly or wired) to the real-world object and, directly or indirectly, operatively connected (wirelessly or wired) to communicate with the VR/AR system. In a preferred embodiment, the object may, for example, be any object or part thereof, such as, for example, a simulated firearm or part thereof (e.g. the lower receiver). A person skilled in the relevant art will understand the term “functional object” refers to objects that have a function or a simulated function that can be presented in a virtual environment (e.g. a firearm) and the function may be activated by the activation of switches or sensors on the object (e.g. a sensor/switch representing a trigger being pressed or otherwise activated by the user).

A person skilled in the relevant art will understand that the term “sensed” will be understood to be different than “tracked” because this term refers to the functional “state” (e.g. on/off, loaded/unloaded, fired/not fired, etc.) of the object that may be being monitored. It will be further understood that this functional state can be altered or reported on by any kind of switches or sensor(s).

Various embodiments of methods and apparatus for providing virtual reality (“VR”), augmented reality (“AR”) and/or mixed reality (“MR”) experiences (collectively referred to as “VR/AR/MR experiences” or “VR/AR/MR systems”) for users are described. Embodiments of VR/AR/MR systems of the present invention are described that may implement VR systems, for example to address problems with high risk training. Over the years a variety of high-risk job training simulators, training devices and other equipment have been suggested, as well as various techniques and methods for their use. Typifying these prior simulators, including weapon simulators, training devices, equipment, techniques, and methods are those described in various US patents. These prior art simulators, training devices, equipment, techniques, and methods have met with varying degrees of success, but are often unduly expensive, difficult to use and create, complex and inaccurate because they fail to consider one or more critical aspects of the training process. Previous training simulators typically rely on a specific “ecosystem” (e.g. devices that only function with other devices that use the same proprietary operating system). These proprietary ecosystems are typically limited to those of the HMD manufacturer used in the training simulator. As a result, functional real-world objects that could be used in the training simulators need to be adapted or modified to work with a particular ecosystem. This limits the ability of full and complete training or entertainment experiences. In current traditional simulation with off-the-shelf HMD's, specially created simulation accessory devices may be needed and these devices are expensive to construct, require electronics expertise and may require technical electronic or mechanical modification to the controllers in order to function as required. In addition, the inherent danger associated with high risk training or events, firearms or other weapons necessitates training and practice in order to minimize the risk of injury. However, special adapters or modifications are typically required to facilitate practice of handling and operating the tools required for high-risk or expensive tasks or experiences.

Embodiments of the VR/AR/MR systems accessory of the present invention may support immersive VR experiences to users with a variety of real-world objects, for example by replacing the view of the real world with any of various types of virtual experiences and environments that a user may experience or desire. Embodiments are directed to physical simulated objects being integrated into the virtual world to help users experience a realistic experience, training scenario or environment. In some embodiments, physical (e.g. real world) simulated firearms or components thereof may be integrated with the VR/AR/MR system to translate physical or real world movement or simulated firearm effects within the virtual experience, for example aiming, discharging the physical simulated firearms, reloading the physical simulated firearm, etc. The preferred embodiments of the present invention convert existing tools or implements, such as operational firearms, into simulated tools that in turn may act as a method of providing inputs or outputs for the VR/AR/MR system while utilizing the already present tracking method via unmodified controllers. Integrating a physical simulated object into a VR system provides opportunities for enhancing virtual experiences that are not available for a projected simulation or a modified controller design to mimic that experience.

Aspects of the present invention provide a method to represent in the virtual environment the position and operation of the physical simulated object. For example, embodiments of the present invention supports the visual representation in the VR/AR/MR environment of the position and operation of the physical object which may be designed to accurately represent the physical (e.g. real world) manipulation of the simulated object to provide a realistic representation in the simulated environment of how the object would operate in the physical world.

In some embodiments, there may be multiple VR events provided as a sequence of VR events as part of a training program. The sequence may be a dynamic sequence that may modify or vary based on the user's actions, inputs, or other aspects of the VR environment.

Embodiments of the present invention provide tracking and input/output support to any controller for a VR, MR or AR system. It will be understood that the controller for the virtual-reality system may comprise multiple controllers; typically controllers are sold in sets or pairs of controllers. In a preferred aspect of the invention, it supports tracking as it exists unmodified via each controller, which connects to the VR/AR/MR system, as well as providing inputs into and outputs from any functional object via a universal housing which connects the controller to the object. Examples of such controllers include, but are not limited to, those provided in Meta Quest 2, Pico Neo 2, etc. The controller may be physically directly or indirectly attached to the functional object but may also be connected to the functional object so that inputs from the functional object can be communicated to the AR/VR/MR system and outputs from the AR/VR/MR system may be communicated to the functional object. In a preferred embodiment of the present invention, any controller can be attached to any object to track that object in VR/AR/MR and provide for such two way communication. In a preferred aspect of the invention, there may be also provided a physical connection to the functional object via an attachment and mount apparatus to an existing object to also sense, detect, or monitor the function(s) of that object.

With the embodiments of the present invention, actions carried out by the user (e.g. physical movements of the object and activation of various object related functions) with the physical object may be accurately represented on the display of the HMD and therefore has more of a feeling of “reality” to the user. This then translates to a more beneficial entertainment or training experience.

The HMD may be conventionally coupled to a processing unit that includes a myriad of operably interconnected components to create the VR environment. According to one embodiment of the invention, the processing unit provides the visual display of: (i) an environmental image for the screen of the head mounted display; (ii) virtual objects and people; (iii) projectile paths; and (iv) any desired item to be reproduced in the virtual environment. It will be understood that the processing unit of the present invention may be any networked computer or other device capable of processing the necessary input to create the virtual environment and presenting it to the user.

According to the present invention, and to impart as much reality into the present invention as possible, various computer programs can be used in conjunction with the microprocessor such that the operation of the functional object (e.g. the position and speed of the object) are known at all times during their schematic illustration on the display of the HMD. Furthermore, the microprocessor controls the environmental image and/or target displayed on the screen of the head mounted display such that the person wearing the display will feel immersed in the environmental image displayed on the screen as a function of the orientation of the head mounted display relative to the fixed location as monitored by the sensor on the display. The computer can be connected via a communications network, such as the Internet, to similar systems, so that competitions or training exercises can be conducted across plural geographic locations. Such competitions or exercises can be controlled from a central system or unit which may be accessible to individual users via an Internet web site.

A preferred embodiment of the present invention may be directed to a communication apparatus for a functional object (e.g. a simulated firearm to be represented in a virtual environment) to be utilized as an entertainment or training device comprising: (a) a controller mount which allows for the unmodified VR/AR/MR system controller to be tracked as the manufacturer intended while being attached to the functional object; (b) a connection housing; and (c) a circuit board or electronics platform provided within the connection housing connected to the controller and the functional object to provide two-way communication between the functional object and the controller and capable of receiving and reading inputs (e.g. activation of a trigger on a simulated firearm, a finger on a button, activation of a sensor, a command from a VR/AR/MR system) and in response to such input, provide an output (show an action in the virtual environment, impact the operation of the object).

In a preferred embodiment, the circuit board may comprise an Arduino BLUETOOTH™ board.

Inside the controller mount and the connection housing of the present invention, there may be provided a circuit board which can be directly or indirectly connected to sensors, which communicate the state of the object to the VR/AR related entertainment or training software, or switches which can be activated to alter the sate of the object. Inside the display (VR/AR/MR headset), the circuit board communicates to the virtual environment software (preferably through the controller) when the user or participant may be “activating” or “not activating” any particular function of the object (e.g. pulling the trigger of a firearm). This happens by way of switches or sensors that indicate when or how the object may be in use, being operated, loaded, reloaded, jamming, etc. In a preferred embodiment, when the embodiments of the present invention are attached to any object, a sensor or switch can be activated which communicates with the VR/AR system to display any pre-programmed result in the HMD of the VR ecosystem. Once any switch may be moved on the object, it communicates to the VR/AR system the appropriate actions so they can be displayed in the HMD.

An aspect of the system of the present invention may be directed to a modular tracking and sensing/detecting/monitoring apparatus for use with virtual environment systems for entertainment or training, for example, configured by the end user. Put plainly, the invention provides a method whereby any object can be both tracked and monitored for any VR/AR/MR ecosystem (e.g. in order to be used in any software program. A user has the option of using their own object of choice with an unmodified, off the shelf VR/AR/MR system for increased familiarity and training experience or use a different object. Existing systems (including for the HTC Vive Pro, HTC Vive Pro 2, utilizing the Vive Tracker) have no ability to be universal, layman-ready, or modular in terms of tracking objects as well as sending and receiving inputs or outputs with real objects from end users. For example, HTC Vive systems only offers tracking components. Current HMD manufacturers also have controllers for their headsets with some input buttons or components but none of which are modular or universal to be applied at the end user level to integrate real physical objects or components as may be done in accordance with the present invention. Some prior art systems provide specific-use kits but a user may mistakenly think these kits can be universally applied to any object, when they are only able to work for specific objects and headsets and are not universal or modular. An aspect of the present invention may be provided for controllers, particularly controllers that are compatible with AR/MR/VR headsets, in that they may easily function as controllers but are not function as a replacement for real objects, such that they will not be mistakenly used in actual training or experiences as those objects. For example, some manufacturers have controllers that allow for tracking and control of virtual objects, but these are less desirable as a user cannot feel or employ the functions of the real object exactly as intended in a universal and realistic manner. Further, none of the current controllers or tracking systems have a universal application to any headset with any kind of controller.

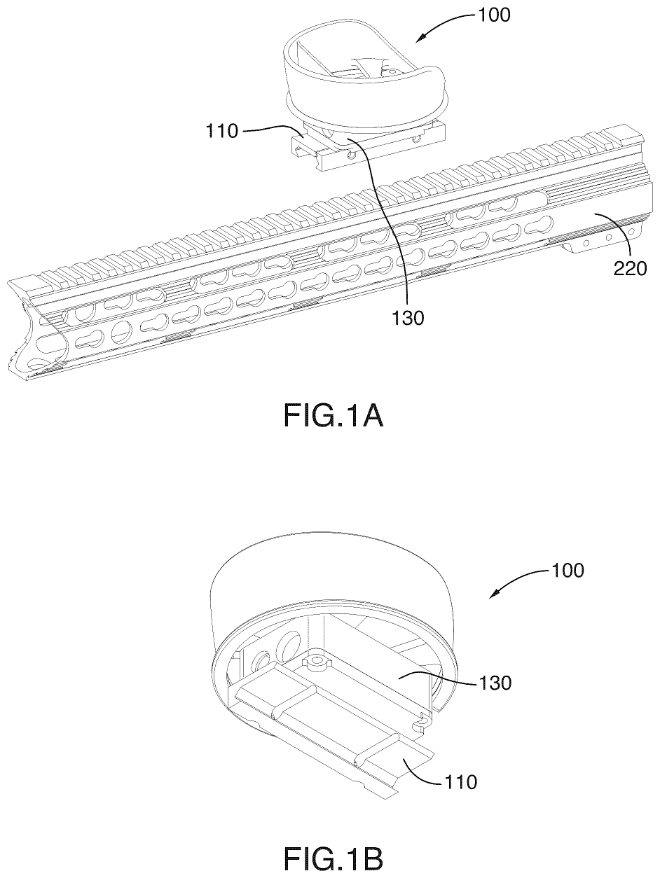

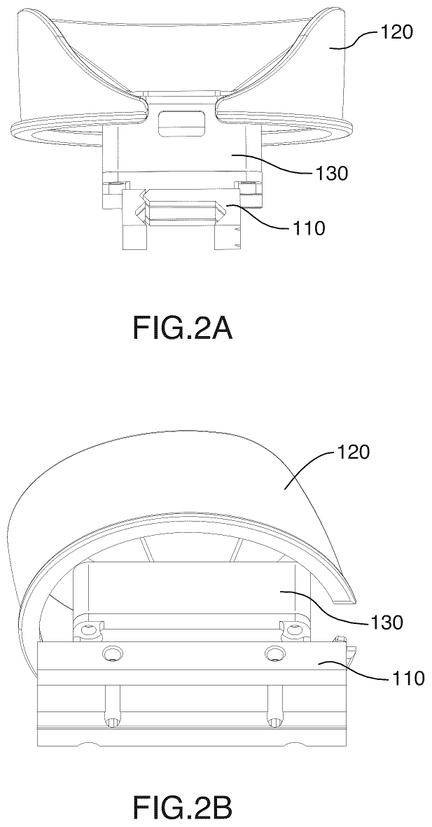

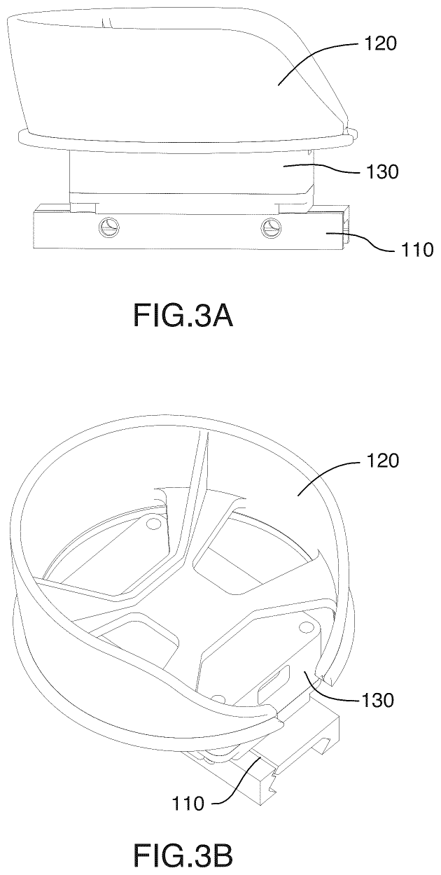

As shown in FIGS. 1(a) and (b), there is provided a tracking and sensing/detecting/monitoring apparatus 100. Tracking apparatus 100 has been modified in accordance with the embodiments of the present invention to be a universal option to maintain an existing HMD manufacturers' tracking system with an easy to use and non-technical bolt on option for attachment to various objects. In the case of the embodiment shown in FIG. 1(a), the apparatus may be configured for attachment to picatinny rail 120, a military standard rail interface system that provides a mounting platform for firearm accessories via mount 110. In accordance with the current invention, the user may modify his/her functional object, with which he/she may be familiar, such that the object becomes akin to a controller within the VR/AR system through the use of the tracking and sensing apparatus by employing the existing tracking method provided by the VR/AR/MR system. More preferably, the embodiments of the present invention may be used in association with systems such as, but not limited to, Meta Quest 2, Pico Neo 2.

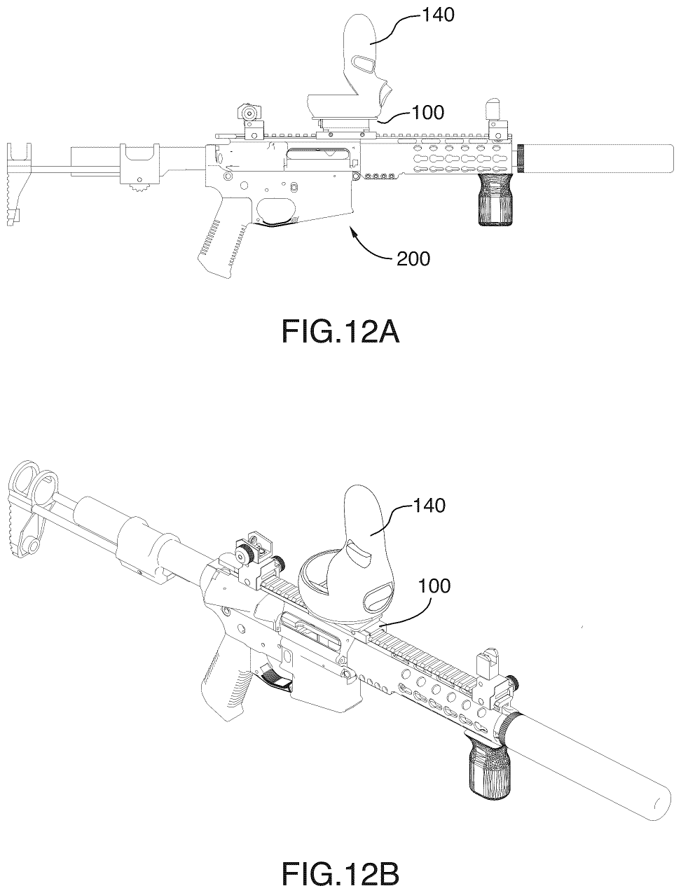

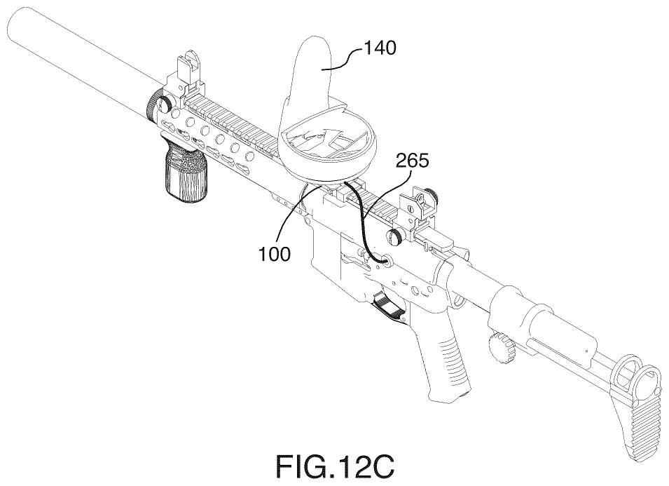

A preferred embodiment may be shown in FIGS. 12(a) to (c). As can be seen in FIGS. 12(a) to (c), the simulated firearm 200 has a barrel 210, a buttstock 225, an upper receiver 230 and a lower receiver 240. Lower received 240 has a trigger (not shown), a pistol grip 245 and a magazine well 246 in which may be provided a magazine 247. As part of the upper receiver, there are provided accessory rails 220 for mounting accessories on the simulated firearm. Mount 110 removably attaches a controller 140 to the accessories rails 220.

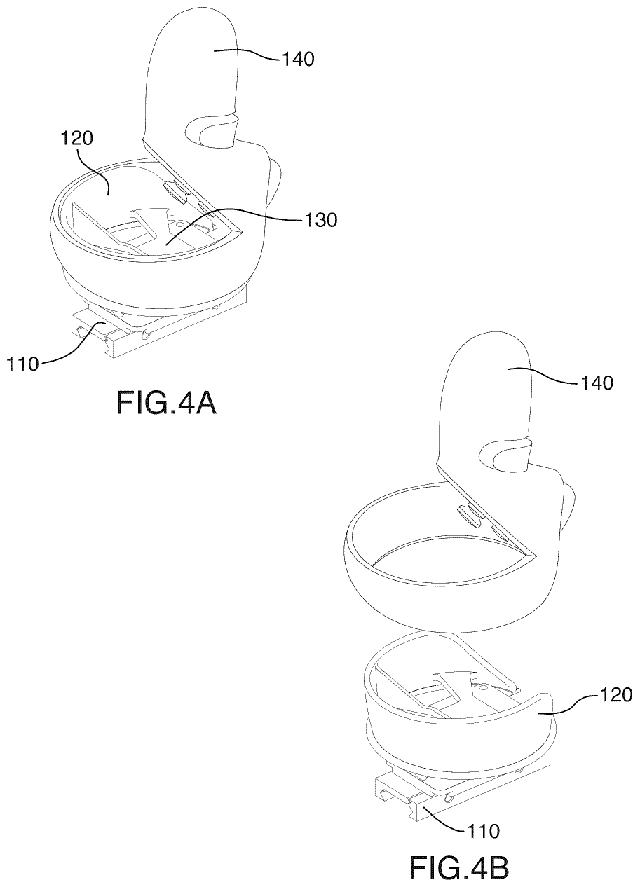

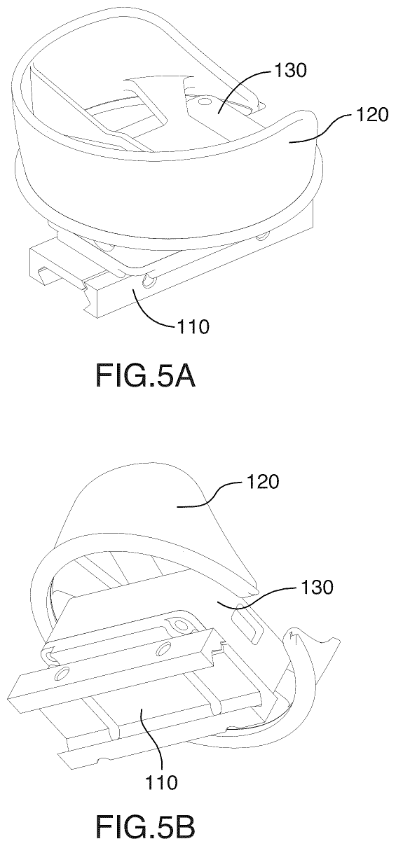

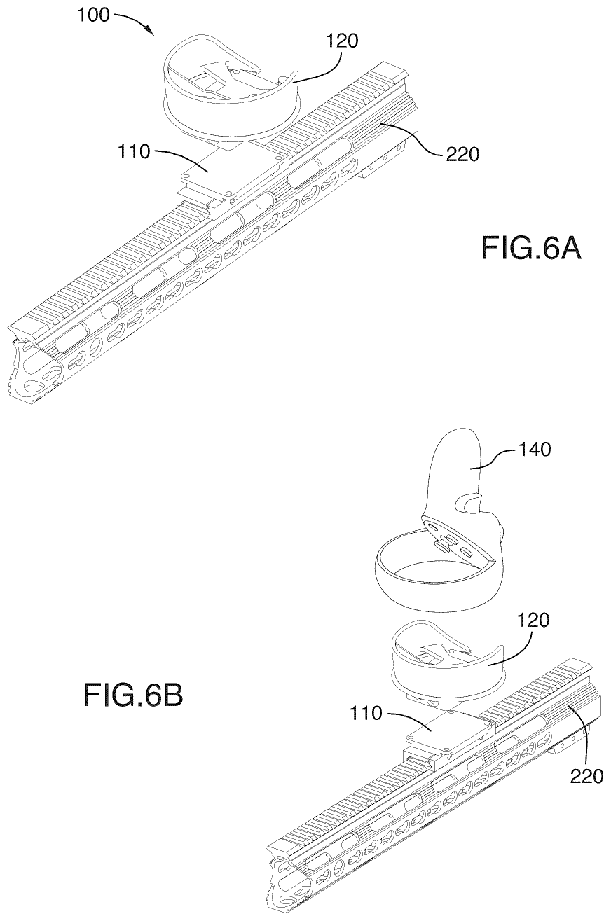

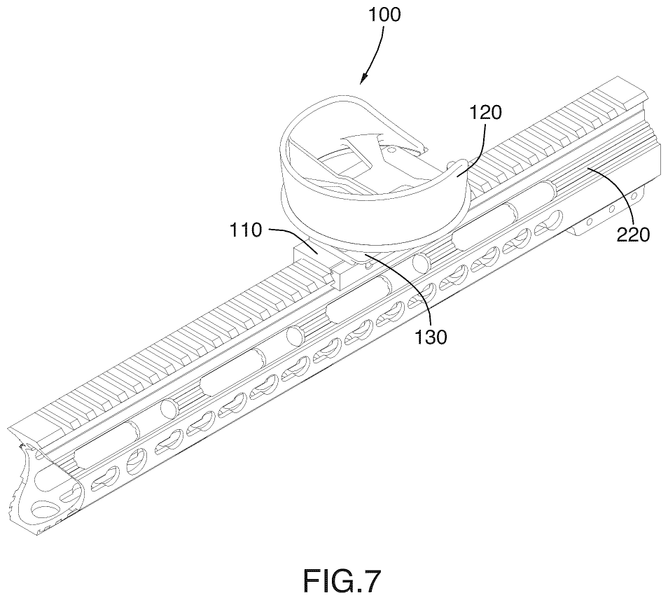

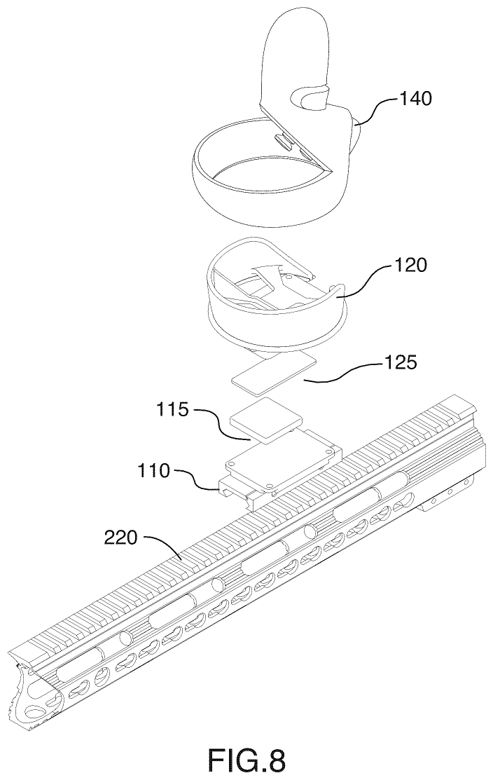

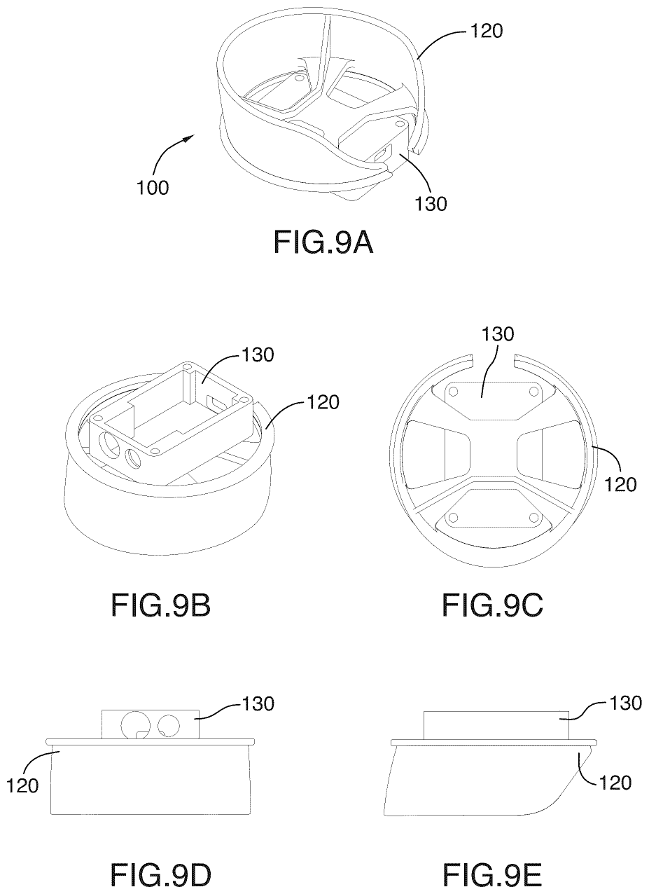

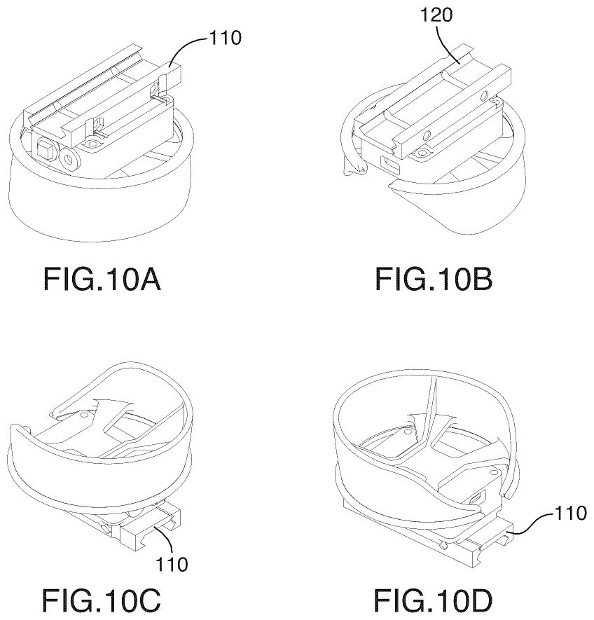

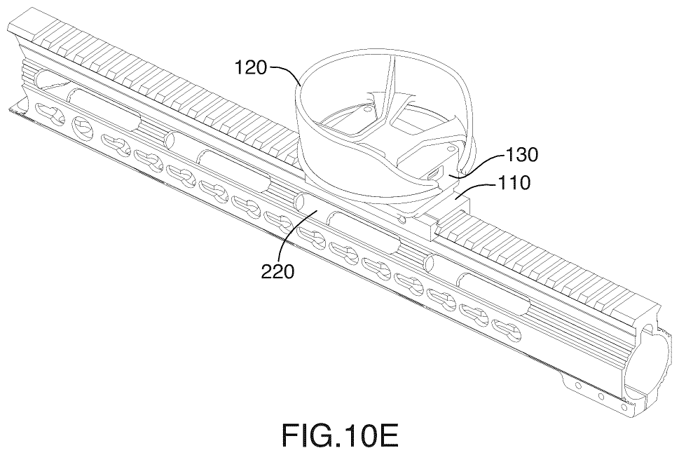

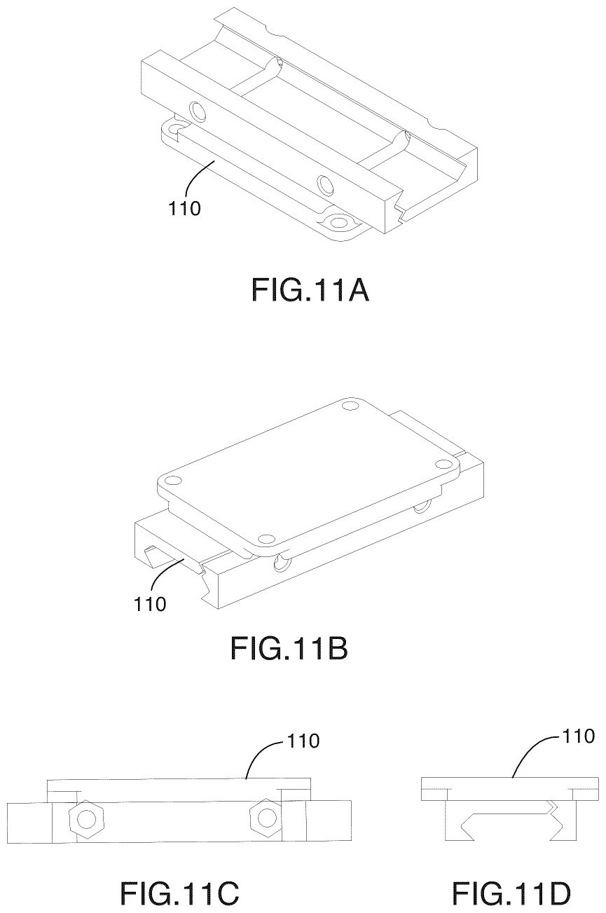

Embodiments of the present invention may use HMD manufacturers existing tracking methods, controllers (see 140 in FIG. 4(a)) and headsets and provide a method to have a controller mounted onto any object see for example, 220 in FIG. 1(a). Another embodiment of the invention may be used with a circuit board to provide inputs and outputs to and from the various switches contained with the functional objects of the present invention and the action buttons, triggers, thumbsticks, etc. of the controller. In that case, after a switch may be activated (e.g. pressed), the VR/AR/MR system's software simulates the action determined in the programming in the VR headset without any disassembly or modification of controllers or the HMD's existing sensing methods required. In addition to simulating the proper functioning of the object, changes to the status of the object can be employed using the software of the present invention. For example, the simulated object can be induced to malfunction via the software using the outputs from the BLUETOOTH™ apparatus. When a malfunction may be simulated, it helps the user work through the realistic occurrence of the problem. A person skilled in the art would understand that simulation and training involves necessarily practicing the malfunctioning of the mechanism. As such, embodiments of the present invention can induce malfunctions or other actions in physical objects and the physical controller can be activated in a particular sequence to remedy the malfunction in VR.

In FIG. 12 (a) to (c), there may be provided sensors and/or switches that can simulate actions corresponding to functional actions or aspects of the actual functional object. As shown in FIGS. 12(a) to (c), there may be provided a simulated firearm 200. The switch 148 can provide a signal (e.g. wired or wireless (e.g. BLUETOOTH™)) to the VR/AR/HR system software through controller 140 to indicate the operation of firearm 200 without actually discharging any projectile or creating the true affected outcome in reality but displaying the discharging or other action in the virtual environment. A firearm, for example in the VR/AR/MR environment may be discharged and the firing of the weapon can then be simulated in the VR/AR/MR environment. If the magazine may be released or inserted, a switch may be activated such that the representation of the firearm in the VR/AR environment simulates the object as being released and inserted in the display.

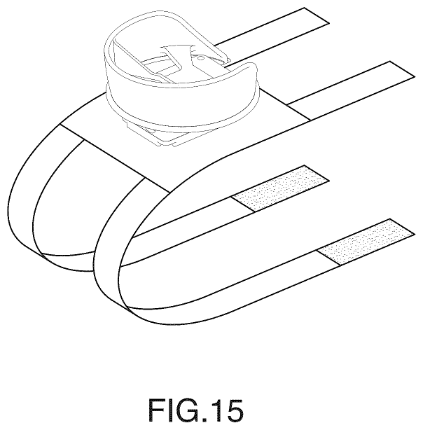

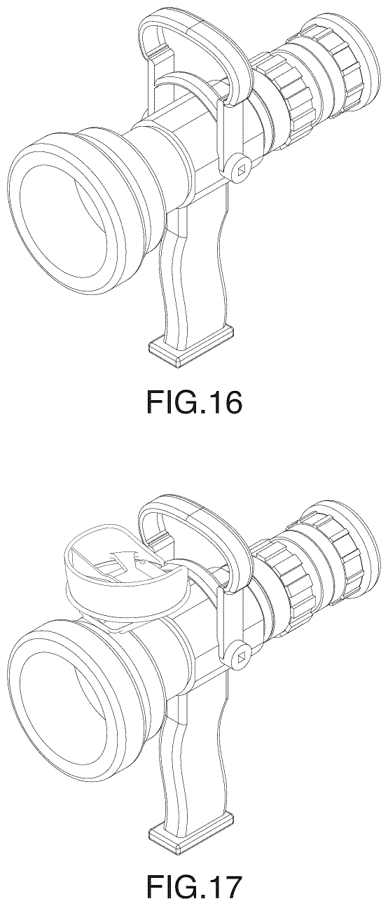

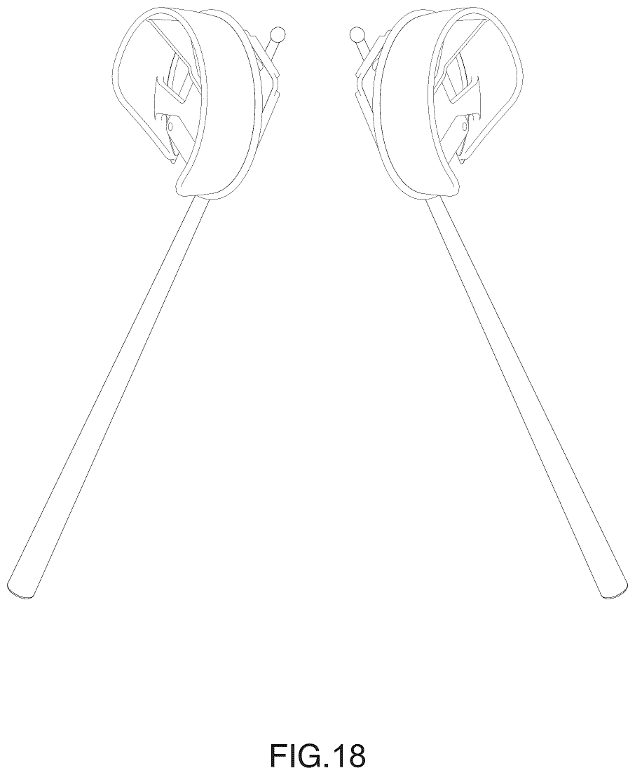

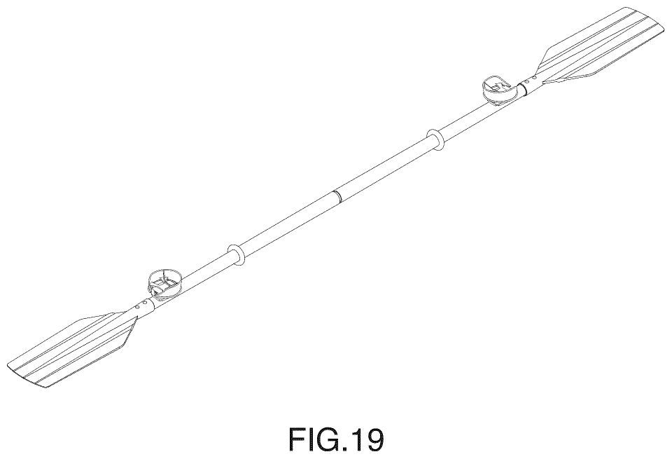

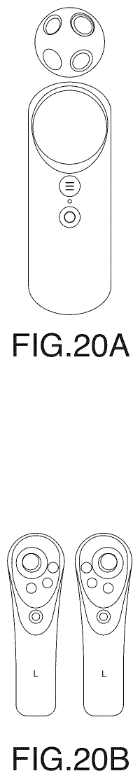

The embodiments of the present invention combine to create a system to (a) utilize the existing VR/AR/MR ecosystem controllers as tracking devices; (b) sense/detect/monitor the functional state of the object electronically without removing the physical or tactile experience from training (using real objects, real adjustments to objects, etc); (c) be easy to use, not require any technical ability or manufacturing capability to deliver inputs or outputs to the headset; and (d) ensure a universal approach through which any object could be both tracked using the existing HMD controller and also sensed/detected/monitored through the circuit board without any significant technical expertise required. FIGS. 15 to 20 show different embodiments of the present invention, particularly trigger switch configurations.

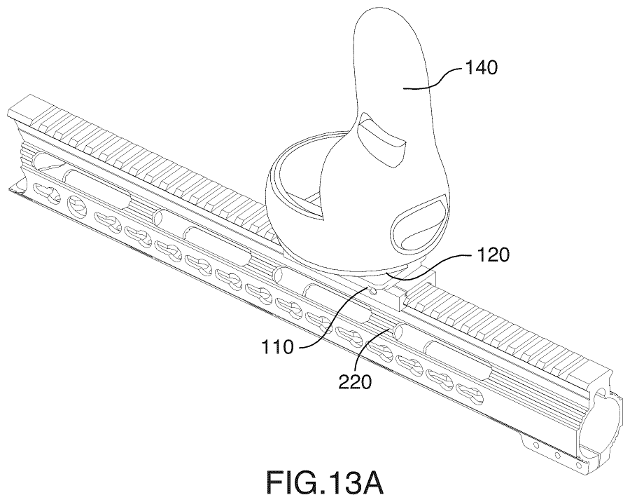

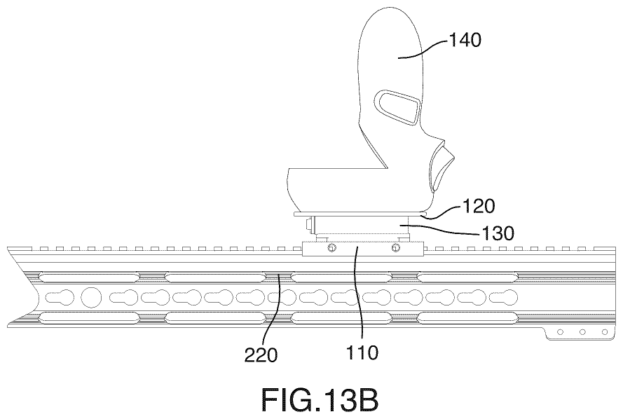

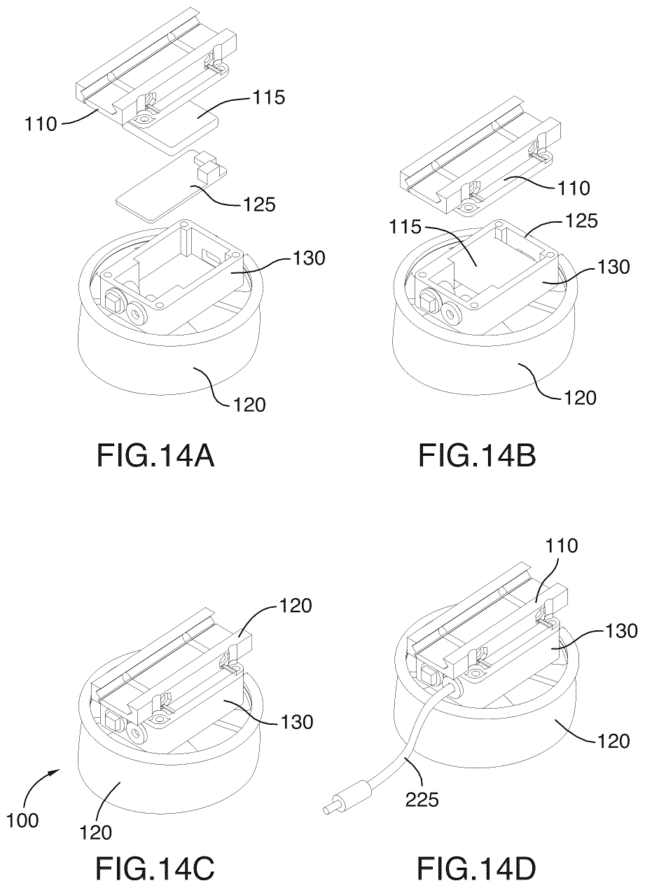

In a preferred embodiment, as shown in FIGS. 13 and 14, the tracking and sensing apparatus 100 can be mounted to a surface of an object via the universal mount 110. The tracking and sensing suite 100 may be secured to an attachment such as, for example, an optic riser that enables the user to mount it to the picatinny rail 220. Once the tracking and sensing apparatus 100 may be mounted to the object, a cable/switch connection 265 (see FIG. 12(c)) may be provided to connect the tracking and sensing apparatus 120 to the object 200. The tracking and sensing apparatus 100 may wirelessly communicate to the display (e.g. the VR/AR headset) through optical sensors on the headset, machine learning in the firmware and by using software and programming. The headset has existing off the shelf properties of machine learning and software which allow it to detect the controller. The headset can track the device with existing off the shelf properties such as machine learning, built-in cameras, IMU's and software, which allow it to detect the controller.

Preferred embodiments of the present invention can be implemented in numerous configurations depending on implementation choices based upon the principles described herein. Various specific aspects are disclosed, which are illustrative embodiments not to be construed as limiting the scope of the disclosure. Although the present specification describes components and functions implemented in the embodiments with reference to standards and protocols known to a person skilled in the art, the present disclosures as well as the embodiments of the present invention are not limited to any specific standard or construction technique.

Although this disclosure has described and illustrated certain preferred embodiments. As shown in FIG. 1, it may be understood that the invention may be not restricted to those particular embodiments. Rather, the invention includes all embodiments which are functional or mechanical equivalence of the specific embodiments and features that have been described and illustrated.

The embodiments of the present invention can apply to any head-mounted display platform of AR/VR/MR that has controllers. Previous devices only works on specific makes or models of AR/VR/MR platforms or related products.

The embodiments of the present invention do not require pin-outs or understanding of how to solder or connect to electronics based on pin-outs. Prior art devices are inherently able to do tracking out of the box but users need to connect to the pinouts underneath the tracker which requires tech expertise and manufacturing to do right.

The embodiments of the present invention have the ability to hold a controller and the BLUETOOTH™ equipment required to detect or monitor any object with switches. Prior art devices or systems may not hold a controller at all, and the inputs may be limited as they don't specifically work over BLUETOOTH™. The embodiments of the present invention may have an unlimited numbers of inputs and outputs while prior art devices have a limited number of devices.

Preferred embodiments of the present invention may allow for sensing and making physical changes in a real world object with an input from the object with a virtual environment output, or vice versa. In the context of a firearm: example of the invention's connected sensor that could be used for trigger, for bolt, for magazine.

In another preferred embodiment of the present invention inputs and outputs may electrically change under open/closed circuit conditions, with optical sensors or other kinds of sensors when the sensor is actuated. Similarly the device can be triggered when the user de-actuates the sensor. Open/closed gets transmitted along the wire (or, if you could use a local non-wireless version like NFC, via that) and received at the circuit board (e.g. Arduino). In a further preferred embodiment, the circuit board (e.g. Arduino) then relays information to translate it into some signal to transmit to the headset, so the headset knows it is meant to be a trigger pull versus an empty magazine condition.

Embodiments of the present invention involve communication devices, techniques, systems and methods, such as BLUETOOTH™, ADRAFRUIT FEATHER NRF52 BLUEFRUIT, etc., to allow for uni- or bi-directional communication between the firearm or simulated firearm or peripheral device and the headset or base station computer. The inputs to such embodiments include, but are not limited to, control signals from the headset/base station, trigger position, trigger touch, magazine status, cartridge status, grip force, slide/bolt position and orientation feedback, etc. The output from the communication device includes communications to the headset/base station, haptic feedback to the user, etc.

The communication between the controller in the firearm and headset/base station has several modes. In one communication mode, the controller may emulate a BLUETOOTH™ HID device whereby the trigger is mapped to a mouse button (left click) and the magazine switch is mapped to another mouse button (right click). In another communication mode, the controller may emulate a BLUETOOTH™ HID keyboard whereby the trigger is mapped to one key and the magazine is mapped to another key. In another communication mode, the controller and base station/headset communicate bi-directionally over BLUETOOTH™ in SPP mode, and the trigger, magazine or other sensor (input) or switch (input) or feedback (output) variables are exchanged between the devices at a set or variable interval. In a preferred embodiment, any off the shelf headset like HTC or Meta (previously known as Oculus) Quest can accept connections via keyboard/mouse command table to trigger a routine, (e.g. “while in PISTOL mode, when receive an ‘F’, instantiate SHOOT_PISTOL routine” and “while in PISTOL mode, when receive an ‘X’, instantiate REMOVE_MAGAZINE routine”). These embodiments may be the functions initiated when the input is triggered (e.g. a BLUETOOTH™ enabled mouse click is received in the headset via Unreal Engine code). An example thereof includes: InputAction TriggerRight->Debug Message->GetControllersSwapped->TriggerGrip Drop.

Although the subject matter has been described in language specific to structural features, it is to be understood that the subject matter defined in the appended claims is not necessarily limited to the specific features described. Rather, the specific features are disclosed as illustrative forms of implementing the claims.

We claim:

1. An apparatus for monitoring and tracking a real-world object having a function in a virtual environment, the apparatus comprising:
(a) a controller mount for receiving a controller used in a virtual environment system for creating the virtual environment, the controller mount connected to the real-world object
(b) a connection housing releasably engaged with the object; and
(c) a circuit board provided within the connection housing connected to the controller and the functional object to provide two-way communication between the functional object and the controller and capable of receiving and reading inputs and in response to such input, provide an output.

2. The apparatus of claim 1 wherein a representation of the real-world object is actively displayed in the virtual environment and the active display of the object corresponds to the movement of the object by a user.

3. The apparatus of claim 2 wherein the user activates the functional of the object and the function is displayed in the virtual environment such that the movement and function of the object is accurately translated into the virtual environment

4. The apparatus of claim 3 wherein the controller provides a signal to the circuit board and the circuit board instructs the object to change the function.

5. The apparatus of claim 4 where the virtual environment system is selected from the group consisting of Meta Quest, the Meta Quest 2, the Pico Neo, the Pico Neo 2, the HP Reverb, the PSVR, the Valve Index, the Pimax 8K X, the Microsoft Hololens, the Microsoft Hololens 2, the Magic Leap, the Magic Leap 2, the Lynx R-1, HP Reverb G2, and the HP Reverb

6. The apparatus of claim 5 wherein the apparatus allow for applying sensors to the object while maintaining the virtual environment system headset's proprietary tracking method provided by the headset manufacturer or a third party tracking method to track the position of the object.

7. The apparatus of claim 6 wherein the apparatus allows a universal and seamless simulation to provide an optimal virtual training environment.

8. The apparatus of claim 6 wherein the apparatus provides for highly accurate operational equipment to be used in a virtual or augmented environment allowing for optimal training, while minimizing downtime.
